(19) United States
(12) Patent Application Publication
(10) Pub. No.: US 2003/0189833 A1
(43) Pub. Date: Oct. 9, 2003

(54) Collapsible lampshade

(76) Inventor: Hsien-Te Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/117,136

(22) Filed: Apr. 8, 2002

(51) Int. Cl. F21V 11/00

(52) U.S. Cl. 362/352; 362/357; 362/450; 362/358

(57) ABSTRACT

A lampshade includes a collapsible frame to which a flexible cover is attached. The frame includes an upper ring and a lower ring. A plurality of support bars are arranged between the upper and lower rings. Each support bar includes an upper section and a lower section hinged to each other. The upper section of the support bar has an end hinged to the upper ring. The lower section of the support bar has an end hinged to the lower ring. The hinge connections between the upper and lower sections of the support bar and between the support bar and the upper and lower rings allow the frame to collapse without separating the parts from each other. A channel member is partially fixed to the upper section of the support bar for partially receiving the lower section of the support bar. Dimples are defined in the lower section of the support for engaging with bosses formed on the channel member for maintaining the support bar in an extended condition.

### BACKGROUND OF THE INVENTION

1. Field of the Invention

The present invention relates generally to a lampshade, and in particular to a lampshade having a collapsible or knock-down configuration.

2. Description of the Prior Art

Lampshades are commonly used for decoration and softening light. Most lampshades do not have a knock-down or collapsible structure, which allows the lampshades to be stored or shipped in a more compact manner. Some knock-down lampshades available in the market allow users to collapse the lampshades, but the lampshades must be at least partially disassembled. This increases the risks of losing parts of the lampshades during shipment and storage.

U.S. Pat. No. 6,315,434B1 discloses a one-piece collapsible lampshade that allows collapse of the lampshade without disassembling the lampshade. The collapsible lampshade of U.S. Pat. No. 6,315,434B1 comprises a collapsible frame over which a shade made of a flexible material is mounted. The frame comprises upper and lower rings spaced from each other. Support bars are arranged between the upper and lower rings. Each support bar has a lower end hinged to the lower ring and an upper end releasably engaging with a corresponding receptacle formed on the upper ring. By releasing the upper ends of the support bars from the upper ring and rotating the support bars to a horizontal, stowed condition, the shade can be collapsed. Such a structure, however, suffers a disadvantage that the upper ring is separated from the frame when the lampshade is collapsed. This may cause undesired damage to the lampshade if not handled carefully.

It is thus desired to provide a collapsible lampshade for alleviating or even overcoming the problems occurring to the conventional collapsible lampshades.

### SUMMARY OF THE INVENTION

An object of the present invention is to provide a collapsible lampshade.

Another object of the present invention is to provide a lampshade having a one-piece collapsible frame to which a flexible cover is attached.

To achieve the above objects, in accordance with the present invention, there is provided a lampshade comprising a collapsible frame to which a flexible cover is attached. The frame comprises an upper ring and a lower ring. A plurality of support bars are arranged between the upper and lower rings. Each support bar comprises an upper section and a lower section hinged to each other. The upper section of the support bar has an end hinged to the upper ring. The lower section of the support bar has an end hinged to the lower ring. The hinge connections between the upper and lower sections of the support bar and between the support bar and the upper and lower rings allow the frame to collapse without separating the parts from each other. A channel member is partially fixed to the upper section of the support bar for partially receiving the lower section of the support bar. Dimples are defined in the lower section of the support for engaging with bosses formed on the channel member for maintaining the support bar in an extended condition.

### BRIEF DESCRIPTION OF THE DRAWINGS

The present invention will be apparent to those skilled in the art by reading the following description of preferred embodiment thereof, with reference to the attached drawings, in which:

FIG. 1 is a perspective view of a lampshade constructed in accordance with the present invention in a fully extended condition;

FIG. 2 is a perspective view similar to FIG. 1, but partially cut away to show inside details;

FIG. 3 is an enlarged view of encircled portion III of FIG. 2;

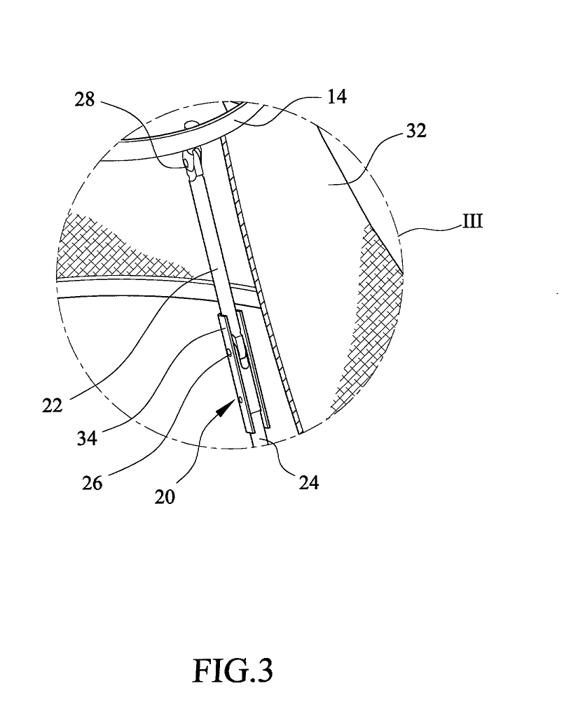

FIG. 4 is a partial cut-away view of the lampshade of the present invention in a partially collapsed condition;

FIG. 5 is an enlarged view of encircled portion V of FIG. 4; and

FIG. 6 is a perspective view of the lampshade of the present invention in a fully collapsed condition.

### DETAILED DESCRIPTION OF THE PREFERRED EMBODIMENTS

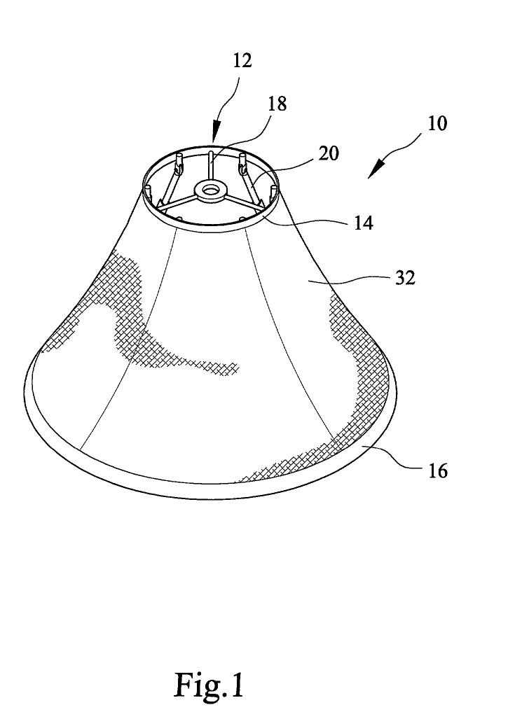

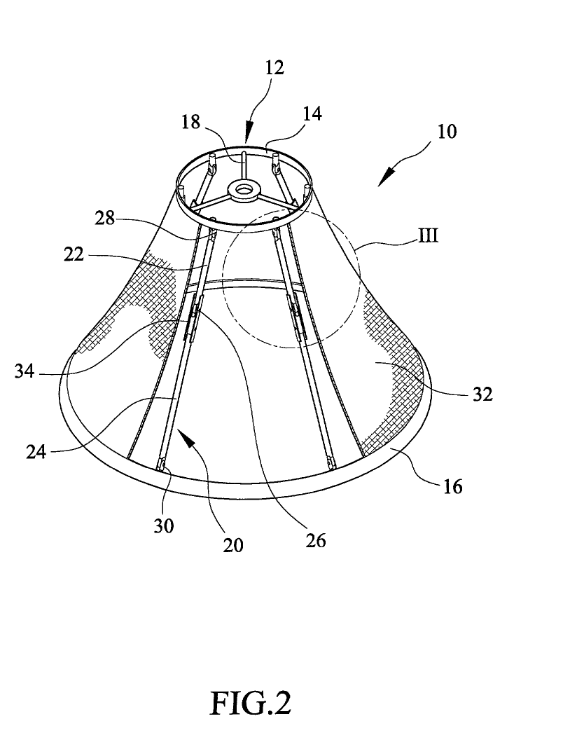

With reference to the drawings and in particular to FIGS. 1 and 2, a lampshade constructed in accordance with the present invention, generally designated with reference numeral 10, comprises a frame 12 comprising an upper ring 14 and a lower ring 16 spaced from each other in a vertical direction. In the embodiment illustrated, the upper and lower rings 14, 16 are circular and the lower ring 1 has a diameter greater than a diameter of the upper ring 14. However, it is apparent that that rings 14, 16 may assume other shapes than circle and the rings 14, 16 may have shapes different from each other. In addition, the lower ring 16 may not necessarily be of larger size than the upper ring 14.

In the embodiment illustrated, spider members 18 lie within the upper ring 14 for providing an attachment point between the lampshade 10 and a lamp (not shown). Since a variety of well-known shade attachment are available in the market, no further detail is needed herein. However, it is noted that the spider members 18 can also lie within the lower ring 16.

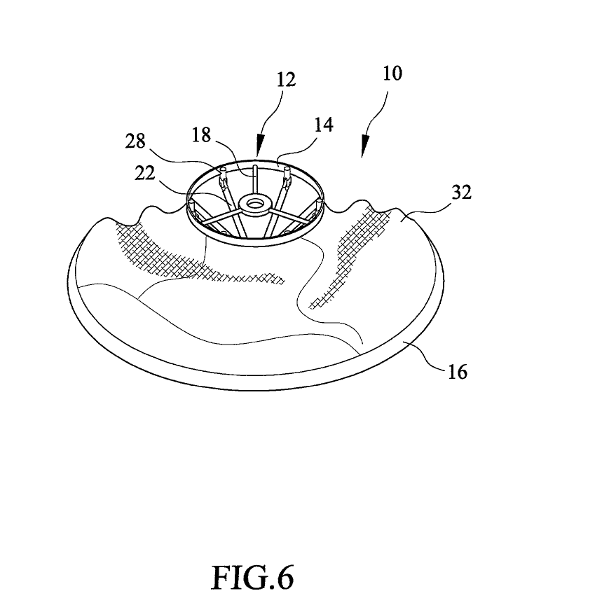

A number of support bars 20 are arranged between the upper and lower rings 14, 16. Each support bar 20 comprises upper and lower sections 22, 24 hinged at 26 to each other. The upper section 22 has an upper end hinged at 28 to the upper ring 14. The lower section 24 has a lower end hinged at 30 to the lower ring 16. The hinges 26, 28, 30 allow the support bars 20 to be moved between a fully extended condition as shown in FIGS. 1 and 2 and a fully collapsed condition as shown in FIG. 6, thereby making the frame 12 collapsible.

A flexible cover member 32, which can be made of for example cloth fabric or any material that can be stretched, is attached to the upper and lower rings 14, 16 and surrounding the frame 12. When the frame 12 is collapsed, the cover member 32 is shrunk and folded. The overall size of the lampshade 10 is thus substantially reduced.

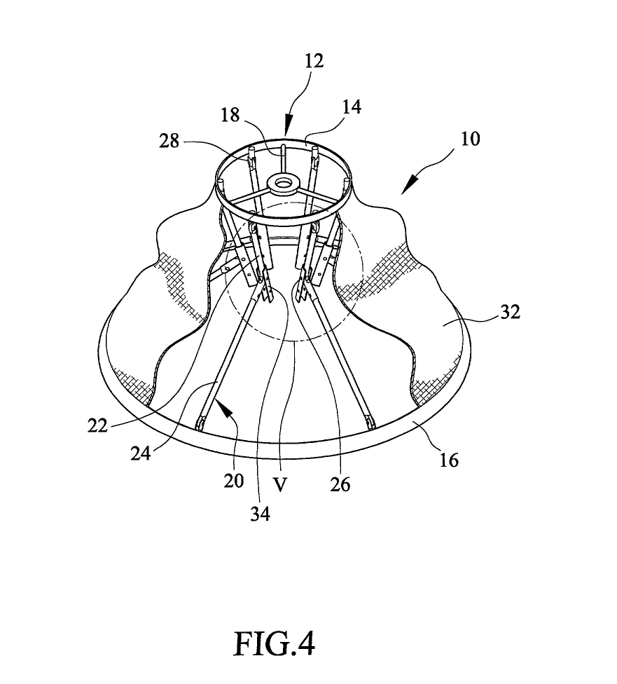

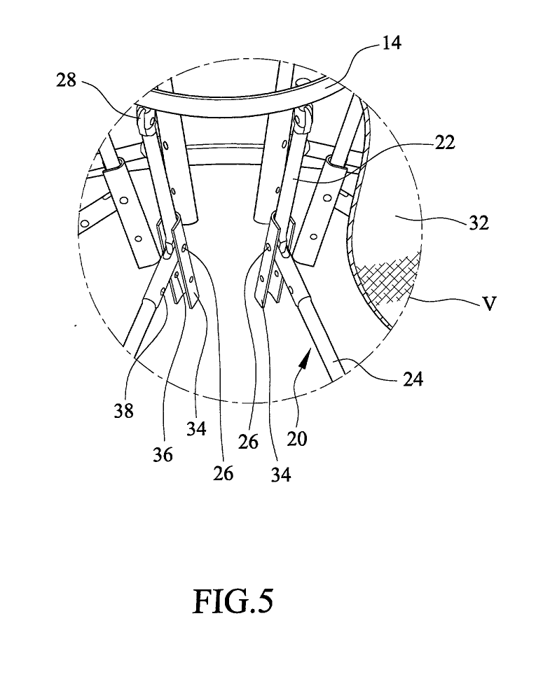

Also referring to FIGS. 4 and 5, the hinge 26 that connects the upper and lower sections 22, 24 of the support bar 20 comprises a channel member 34 having an upper portion (not labeled) fit over and fixed to the upper section 22 and a lower portion for partially receiving the lower section 24 therein. Bosses 36 are formed on opposite inside faces (not labeled) of the channel member 34 and corresponding dimples 38 are defined in the lower section 24 whereby when the support bar 20 is fully extended, the bosses 36 engage the dimples 38 to maintain the fully extended condition of the support bar 20. Alternatively, the dimples may be defined in the channel member 34 and the bosses formed on the lower section 24 of the support bar 20.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A lampshade comprising:
a frame comprising:
a first ring,
a second ring, and
a plurality of support bars, each support bar comprising a first section having an end hinged to the first ring and a second section hinged to the second section, the first and second sections being hinged to each other; and
a flexible cover member attached to the first and second rings and surrounding the frame.

2. The lampshade as claimed in claim 1, wherein a channel member is partially fixed to the first section for partially receiving the second section therein.

3. The lampshade as claimed in claim 2, wherein bosses are formed on the channel member for engaging dimples defined in the second section of the support bar for maintaining the support bar in an extended condition.

4. The lampshade as claimed in claim 1, wherein a lamp attachment is formed with the first section of the support bar for supporting a lamp.

5. The lampshade as claimed in claim 4, wherein the lamp attachment is fixed to the first ring by spider members extending therebetween.
